(19) United States
(12) Patent Application Publication
(10) Pub. No.: US 2008/0090166 A1
(43) Pub. Date: Apr. 17, 2008

(54) Addition of extra particulate additives to chemically processed toner

(76) Inventors: Rick Owen Jones, Berthoud, CO (US); George Pharris Marshall, Denver, CO (US); John Melvin Olson, Boulder, CO (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/549,225

(22) Filed: Oct. 13, 2006

(51) Int. Cl. G03G 9/08

(52) U.S. Cl. 430/137.1

(57) ABSTRACT

The present invention relates to the combination of a chemically processed toner with extra particulate additive in a conical mixer. The toner may include polymer resins having a glass transition temperature (Tg) wherein the mixer and/or toner may be maintained below the glass transition temperature during mixing. Prior to mixing the toner particles may also be de-agglomerated or mechanically agitated.

### CROSS-REFERENCES TO RELATED APPLICATIONS

This patent application is related to the U.S. patent application Ser. No. ______, filed MONTH DAY, 2006, entitled “METHOD OF ADDITION OF EXTRA PARTICULATE ADDITIVES TO IMAGE FORMING MATERIAL” and assigned to the assignee of the present application.

### FIELD OF INVENTION

The present invention relates to a method of adding extra particulate additives to an image forming substance, such as chemically processed toner (CPT) used in an image forming apparatus. The extra particulate additives may be combined with the toner wherein the temperature of the toner during the mixing process may be monitored and controlled. An image forming apparatus may include, for example, copiers, faxes, printers, electrophotographic printers, multi-functional devices or all-in-one devices.

### BACKGROUND

Toner may be formed by the process of compounding a polymeric resin, with colorants and optionally other additives. These ingredients may be blended through, for example, melt mixing. The resultant materials may then be ground and classified by size to form a powder. Toner compositions may also be formed by chemical methods in which the toner particles are prepared by chemical processes such as suspension or aggregation rather than being milled from larger sized materials by physical processes. Toner compositions so formed may be used in printers and copiers, such as laser printers wherein an image may be formed via use of a latent electrostatic image which is then developed to form a visible image on a drum which may then be transferred onto a suitable substrate.

### SUMMARY

In one exemplary embodiment, the present invention relates to a method for adding extra particulate additive to chemically processed toner. The method may include combining chemically processed toner and extra particulate additive to form a mixture in a conical mixer. The toner may include polymeric material having a glass transition temperature (Tg) and the mixing may be carried out wherein the mixture is maintained at a temperature less than Tg.

In another exemplary embodiment the present invention relates again to a method for adding extra particulate additive to chemically processed toner. The method may include combining chemically processed toner and extra particulate additive to form a mixture in a conical mixer having a rotor and one or more mixing paddles. The toner may include polymeric material having a glass transition temperature (Tg) and the mixing may be carried out in a plurality of stages each having a selected RPM value and time T for mixing wherein RPM₁<RPM₂ and T₂>T₁. In this situation RPM₁ represents the conical rotor rpm in stage 1, RPM₂ represents the conical rotor rpm in stage 2, T₁ represents the time for mixing in stage 1 and T₂ represents the time for mixing in stage 2. The mixture may also be maintained at a temperature less than Tg and the extra particulate additive may be present at a level of less than about 5.0% (wt.) within the toner.

In yet another exemplary embodiment, the present invention relates again to a method for adding extra particulate additive to chemically processed toner. The method may include combining chemically processed toner including toner particles having a particle diameter in the range of about 1-25 microns with extra particulate additive to form a mixture in a conical mixer. The toner may comprise a plurality of polymer materials, each having a Tg. The method may then include identifying the lowest relative Tg wherein the temperature of the mixture may be maintained at a temperature that is lower than the lowest relative Tg

### DETAILED DESCRIPTION

The present invention relates to a method of adding extra particulate additives to image forming substances, and in particular to chemically processed toner, for use in an image forming apparatus. In particular, the temperature of the toner may be monitored and controlled during the mixing process. An image forming apparatus may include, for example, copiers, faxes, electrophotographic printers, printers, multi-functional devices or all-in-one devices.

The toner particles may be advantageously prepared by chemical methods, and in particular via an emulsion aggregation procedure, which generally provides resin, colorant and other additives. More specifically, the toner particles may be prepared via the steps of initially preparing a polymer latex from unsaturated olefin type monomers, in the presence of an ionic type surfactant, such as an anionic surfactant having terminal carboxylate (—COO⁻) functionality. The polymer latex so formed may be prepared at a desired molecular weight distribution (MWD=Mw/Mn) and may, e.g., contain both relatively low and relatively high molecular weight fractions to thereby provide a relatively bimodal distribution of molecular weights. Pigments may then be milled in water along with a surfactant that has the same ionic charge as that employed for the polymer latex. Release agent (e.g. a wax or mixture of waxes) may also be prepared in the presence of a surfactant that assumes the same ionic charge as the surfactant employed in the polymer latex. Optionally, one may include a charge control agent.

The polymer latex, pigment latex and wax latex may then be mixed and the pH adjusted to cause flocculation. For example, in the case of anionic surfactants, acid may be added to adjust pH to neutrality. Flocculation therefore may result in the formation of a gel where an aggregated mixture may be formed with particles of about 1-2 μm in size.

Such mixture may then be heated to cause a drop in viscosity and the gel may collapse and relative loose (larger) aggregates, from about 1-25 μm, may be formed, including all values and ranges therein. For example, the aggregates may have a particle size between 3 μm to about 15 μm, or between about 5 μm to about 10 μm. In addition, the process may be configured such that at least about 80-99% of the particles fall within such size ranges, including all values and increments therein. Base may then be added to increase the pH and reionize the surfactant or one may add additional anionic surfactants. The temperature may then be raised to bring about coalescence of the particles, which then may be washed and dried. Coalescence is referenced to fusion of all components.

The above procedure therefore offers flexibility in the selection of resin components and pigments (colorants) and it may be appreciated that a wide variety of surfactants (either anionic or cationic) may be employed. As noted, the process may rely upon pH to alter the charge on a surfactant to stabilize disperse particles, which may amount to deprotonating a cation or protonation of an anion.

As alluded to above, the resins contemplated herein may therefore include resins sourced from monomers having ethylenically unsaturated bonds that may be subject to free radical polymerization. The resins may therefore include styrenes, acrylates, methacrylates, butadiene, isoprene, acrylic acid, methacrylic acid, acrylonitrile, vinyls, etc. Other resins may also be contemplated such as condensation polymers, including polyamide and/or polyester resins, of a linear, branched or even crosslinked configuration. The resins may also be modified such that they contain functional groups (e.g. an ionic group) which may allow the resin to more directly disperse in an aqueous medium without the need for surfactants.

Where the polymeric resins are prepared via emulsion or suspension polymerization, initiators may include, for example, peroxides or persulfates. Water soluble initiators may be employed in the case of an emulsion polymerization and water insoluble initiators may be employed in the case of suspension polymerization.

The various pigments which may be included include pigments for producing cyan, black, yellow or magenta toner particle colors. The pigments themselves may range in particle size between 60 nm and 2 μm, including all values and increments therebetween. The pigments may be included within a range of about 2 to 12% by weight. Additional additives may also be incorporated into the toner particles such as charge control agents and release agents. Such additives may be incorporated into the pigment latex or may be incorporated in the polymer latex.

Release agents may be included in the final toner composition within a range of greater than about 3.0% by weight (wt.), including all values and ranges therein, such as between about 4% to 15.0% by weight, or at a more specific level of, e.g. about 10%. The release agent may also have a number average molecular weight (Mn) of greater than about 500. Moreover, the release agent may have a Mn of between about 501-20,000, including all values and increments therein.

Exemplary release agents may include one or more vegetable waxes, mineral waxes, petroleum waxes or synthetic waxes, such as hydrocarbon wax, paraffin wax, carnauba wax, chemically modified waxes, etc. For example, for a given weight percent of release agent, the release agent may comprise a mixture of waxes. That is, the hydrocarbon wax may account for 20-99% of the mixture and a carnauba wax may be present that accounts for 1-80% of the mixture, including all values and increments therein. The hydrocarbon wax may specifically be sourced as a “Fischer-Tropsch” wax. Accordingly, in an exemplary embodiment, the release agent may include a formulation that contains greater than 50% Fischer Tropsch wax relative to the presence of the carnauba wax. For example, a release agent formulation that contains about 80% Fischer Tropsch wax and about 20% carnauba wax. In that sense the invention herein contemplates a mixture of a hydrocarbon (or relatively non-polar) wax in combination with waxy substances that are relatively more polar, and are based upon esters of fatty acids, fatty alcohols, esterified fatty diols, and hydroxylated fatty acids.

The release agent, in the form of a wax, may also have a specific wax domain size in the toner particles which may be monitored and controlled in the following manner. The toner particles may be embedded in a cured polymeric type resin and sections of about 25-300 nm may be cut using a diamond knife. Transmission electron microscopy (TEM) images may then be employed at about 17,000 magnification. The size of about 100 wax domains may then be measured using image analysis software (e.g., Zeiss KS300). Pursuant to this methodology, the wax domain size may be controlled to have a mean wax domain size of between about 0.10-1.20 μm, including all values and increments therein. For example, the wax domain size may have a value of about 0.40-1.00 μm, or 0.50-0.90 μm, or the individual values of about 0.50 μm, 0.60 μm, 0.70 μm, etc. Furthermore, the wax may have a minimum wax domain size of 0.01 microns and a maximum wax domain size of about 4.0 microns. Such wax domain size may effect and advantageously define or influence the compatibility of the wax within a given continuous phase of resin polymer.

The release agent (wax) may also have a crystalline phase as defined by a differential scanning calorimetry (DSC) peak melting point temperature of between about 75° C. to about 105° C. This may be understood at the peak in the melting endotherm of the wax within a toner composition (e.g. black, cyan, magenta or yellow) by a given DSC heating scan. Furthermore, the wax herein may have more than one crystalline form or size as defined by multiple peak melting points (i.e. a plurality of peaks) within the range of 75-105° C. In addition, the release agent (wax) may be characterized herein by a DSC onset melting temperature. This may correspond to the temperature at which a first endothermic melting event may begin (i.e. shift from a baseline) on a given DSC trace. Such DSC onset melting temperature of the release agent (wax) herein, suitable to optimize release performance in a given electrophotographic printer, may be equal to or greater than about 40° C. It may also be equal to or greater than about 50° C., 60° C., 70° C., including any temperature up to about 100° C.

The resulting toner particles may also be optimized for performance and characterized by rheological considerations, such as a complex viscosity (\acute{η}) between about 500 to 1500 Pa·s at 160° C. and a tan delta value of between about 0.4 to 2.5. Table 2 illustrates exemplary toner particle complex viscosity and tan delta measurements. The measurements were performed at a sinusoidal oscillation frequency of 6.28 rad/s, using a 25 mm sample.

TABLE 2
Viscosity Measurements

| | Complex Viscosity @ | |
|---|---|---|
| Toner | 160° C. [Pa · s] | Tan Delta |
| Cyan | 731.8 | 0.736–2.165 |
| Black | 1204.9 | 0.813–2.405 |
| Yellow | 998.8 | 0.824–2.125 |
| Magenta | 1096.3 | 0.455–1.672 |

The present invention also operates to provide finishing to toner particles, as more specifically described below. Such finishing may rely upon what may be described as a device of mixing, cooling and/or heating the particles which is available from Hosokawa Micron BV and is sold under the trademark CYCLOMIX®. Such a device may be understood as a conical device having a cover part and a vertical axis wherein the device narrows in a downward direction. The device may include a rotor attached to a mixing paddle that may also be conical in shape and may include a series of spaced, increasingly wider blades extending to the inside surface of the cone that may serve to agitate the contents as they are rotated. Shear may be generated at the region between the edge of the blades and the device wall. Centrifugal forces may therefore urge product towards the device wall and the shape of the device may then urge an upward movement of product. The cover part may then urge the products toward the center and then downward, thereby providing a feature of recirculation.

The device as a mechanically sealed device may operate without an active air stream, and may therefore define a closed system. Such closed system may therefore provide relatively vigorous mixing and the device may also be configured with a heating/cooling jacket, which allows for the contents to be heated or cooled in a controlled manner, and in particular, temperature control at that location between the edge of the blades and the device wall. The device may also include a temperature probe so that the actual temperature of the contents can be monitored. An exemplary conical mixing device is described in U.S. Pat. No. 6,599,005 whose teachings are incorporated by reference.

Accordingly, the toner particles may be combined with extra particulate additives (EPA). As alluded to above, such additives may serve to improve the flow or physical conveyance of the above-referenced chemically produced toner particles within an image forming apparatus and in such a manner improve properties such as charge, ghosting, line width and voiding. The extra particulate additives may therefore be understood to be a solid particle of any particular shape. Such particles may be of micron or submicron size and may have a relatively high surface area. The extra particulate additives may be organic or inorganic in nature. For example, the additives may include a mixture of two inorganic materials of different particle size, such as a mixture of differently sized fumed silica. The relatively small particles may provide a cohesive ability, e.g. the ability to improve powder flow of the toner. The relatively larger sized particles may provide the ability to reduce relatively high shear contact events during the image forming process, such as undesirable toner depositions (filming).

The fumed silica contemplated herein may be sourced for example from Degussa Corporation, under the trademark AEROSIL® and may include, for example, product grades RY50, A380, NY50 or R812. In addition the silica particles may be surface treated with silicone oil. The particles may have a negative electrostatic charge in the range of −400 to −600 μC/g, including all values and increments therein, and a specific surface area of between about 10-50 m²/g, including all values and increments therein. The inorganic additives may also include oxides, such as fumed oxides or precipitated oxides. For example, silica, titania and other oxides may be utilized. The extra particulate additives may be added up to 5.0% by weight (wt.) within a given toner formulation, including all values and increments therein. For example, the extra particulate additive may be added up to about 2.5% (wt.).

The extra particulate additives herein may also be acicular in structure having a length of between about 1 to 10 microns and any increment or value therein and a diameter of between about 0.01 to 100 microns and any increment or value therein. Acicular may be understood as a general reference to a shape wherein one dimension (e.g., length) exceeds another dimension (e.g., width). The particles may specifically include metal particles or metal oxide particles, such as titanium dioxide. The particles may also be surface treated. For example, the acicular particles may be treated with silicon oxide and/or one or more metal oxides, including for example aluminum oxide, cerium oxide, iron oxide, zirconium oxide, lanthanum oxide, tin oxide, antimony oxide, indium oxide, etc. One particular exemplary particle includes acicular titanium dioxide particles surface treated with aluminum oxide, which may be obtained from Ishihara Corporation, USA. The acicular particles may also be treated with one or more organic reagents, such as a functional organic reagent to modify hydrophobic or hydrophilic surface characteristics.

For example, chemically processed toner, which as alluded to above may be understood as toner sourced from a chemical aggregation technique, may be combined with one or more extra particulate additives and placed within the above referenced conical mixing vessel. The temperature of the vessel may then be controlled such that the toner polymer resins are not exposed to a corresponding glass transition temperature or Tg which may lead to some undesirable adhesion between the polymer resins prior to mixing and/or coating with the EPA material. Accordingly, the heating/cooling jacket may be set to a temperature of less than or equal to the Tg of the polymer resins in the toner, and preferably to a cooling temperature of less than or equal to about 25° C. As discussed above with relation to release agents melting points it should be understood herein that Tg may be identified by differential scanning calorimetry (DSC) wherein the Tg may be recorded as either the departure from the baseline in the DSC thermogram (Tgₒₙₛₑₜ) or the midpoint of the identified and measured change in heat capacity (Tg_{midpoint}) at a heating rate of less than or equal to about 10° C. per minute.

Expanding upon the above, it can now be appreciated that for a given polymer resin and a given Tg that may be associated with such resin, the heating/cooling jacket may be set to a temperature that is at least about 5° C. or more below such Tg, including all values and increments therein. For example, the heating/cooling jacket may be set to a temperature that is 10° C. below Tg, or a temperature that is between about 10-100° C. below Tg, including all values and increments therein. Furthermore, it may also be appreciated that in the case of a toner that may include more than one polymer resins, one may identify the lowest relative Tg of any such mixture of resins and then control temperatures of the heating/cooling jacket with respect to such identified Tg value. It should also be understood that with respect to a mixture of polymer resins, the resins may have about the same Tg value, in which case the lowest relative Tg may be the same within the mixture.

Apart from setting the heating/cooling jacket to such temperature, the internal temperature probe may also be set to such temperature, so that the contents are similarly monitored and controlled to such temperature limits. Additionally, one may detect the toner temperature via the internal temperature probe and utilize such detected readings to control the temperature of the toner via a control device such as a comparator, programmable logic controller or other device known in the art which may be used to control the jacket temperature. One may therefore understand reference herein to setting the temperature probe to include setting the control device reference temperature or desired temperature at which the toner particles may be maintained during the mixing process. Accordingly, one then may proceed as noted above, and control the heating/cooling jacket and/or the internal temperature probe with respect to such identified Tg value.

The conical mixing device with such temperature control may then be operated wherein the rotor of the mixing device may be configured to mix in a multiple stage sequence, wherein each stage may optionally be defined by a selected rotor rpm value (RPM) and time (T). Such multiple stage sequence may be particularly useful in the event that one may desire to provide some initial break-up of CPT agglomerates. For example, the rotor may be initially operated to mix at a value of less than or equal to about 500 rpm, including all values and increments therein. More specifically, the rotor may be operated at a value of between about 300-400 rpm, or at a value of about 300-350 rpm, or at a value of about 325 rpm. In addition, such initial first stage of mixing may be controlled in time, such that the conical mixer operates at such rpm values for a period of less than or equal to about 60 seconds, including all values and increments therein. Then, in a second stage of mixing, the rpm value may be set higher than the rpm value of the first stage, e.g., at a rpm value greater than about 500 rpm. For example, the rotor may be operated in a second stage at an rpm value of about 750-2000 rpm, including all values and increments therein. Preferably, the rpm value in the second stage of mixing may be about 1000-1500 rpm, or even 1300-1400 rpm. Furthermore, the time for mixing in the second stage may be greater than about 60 seconds, and more preferably, about 60-180 seconds, including all values and increments therein. For example, the second stage may therefore include mixing at a value of about 1300-1350 rpm for a period of about 90 seconds.

It can therefore be appreciated that with respect to the mixing that may take place as applied to mixing EPA with chemically processed toner, such mixing may efficiently take place in multiple stages in a conical mixing device, wherein the RPM₁<RPM₂ and wherein T₂>T₁. In this situation RPM₁ represents the conical rotor rpm in stage 1, RPM₂ represents the conical rotor rpm in stage 2, and T₁ represents the time for mixing in stage 1 and T₂ represents the time for mixing in stage 2. In addition, the temperature of the mixing process may again be controlled within such multiple staged mixing protocol such that the heating/cooling jacket and/or the polymer within the toner (as measured by an internal temperature probe) is maintained below its glass transition temperature (Tg).

Expanding upon the above, and in the case where it may be useful to provide some initial break-up (e.g. mechanical agitation) of CPT agglomerates, the chemically processed toner may be placed in a conical mixer wherein the internal temperature probe may be set to about 25° C. and the outer heating/cooling jacket is set to about 20° C. The rotor/mixing paddles may then be rotated at about 300-350 rpm for a period of 15-25 seconds, followed by rotation at about 2000 rpm for about 90-150 seconds. At this point, the extra particulate additive may be added and mixing may proceed wherein, again, the temperature of the device may be maintained at a temperature less than Tg of the polymer resin(s) within the toner or the actual temperature of the contents may be directly monitored and regulated to achieve a temperature below Tg.

With respect to the foregoing, it has been recognized that chemically processed toner may provide additional challenges with respect to a finishing operation (i.e. addition of EPA). For example, it has been observed that the relatively smoother and relatively more uniform toner particle surface afforded by the CPT methodology may make it relatively more difficult to promote adhesion as between CPT particles and extra particulate additives. The use of the conical mixer herein has therefore provided a more efficient process for application of the EPAs to the surface of the CPT toner, which may then provide a relatively improved level of toner performance.

For example, CPT toner was comparatively finished in a Waring Blender, which affords a relatively small batch size and relatively vigorous stirring. Such toner, however, demonstrated relatively poor mass flow characteristics. The CPT toner was then comparatively finished in a Henschel mixer which resulted in relatively slight improvement in performance. By contrast, when the CPT toner was finished (combined with EPA) in a conical mixer, as described above, the toners showed adequate charging and relatively good overall performance (e.g., improved print quality, lower susceptibility to “brick”, improved transfer and improved dot development and dot shape). An exemplary side-by-side comparison is provided below in Table 1.

TABLE I
Comparative Finishing

| | | | Line | Line | | |
|---|---|---|---|---|---|---|
| | | Ghosting | Widths | Widths | Voiding | Voiding |
| Toner | Finishing | Metric | 3 pel | 4 pel | 3 pel | 4 pel |
| 1 | Conical | 48 | 153μ | 187μ | 13% | 8% |
| 2 | Henschel | 53 | 154μ | 195μ | 15% | 8% |

In Table 1 above, the ghosting phenomenon typically results when an image is developed with toner from a toner donor roller (e.g. developer roller) which has not been completely retoned since the last image was developed. When this occurs, the normal development of imagery may be superimposed over a residual pattern resulting from the last image developed. In normal development, toner is removed from the surface of the developer roller as it is driven therefrom towards the latent image on the surface of the PC drum under the influence of electric fields. It is desirable to not remove 100% of the toner present as it may be difficult to retone the roller in a single revolution before development is required on the next roller revolution. If 100% of the toner present on the roller surface is required, and the roller surface has not been completely retoned, development will be deficient in certain areas resulting in a ghosting effect. Less ghosting means better observed print quality (e.g., 48 for the Conical mixer vs. 53 for the Henschel mixer).

Line width (3 pel and 4 pel) is another variable which relates to the precise development of lines, and is generally indicative of the cohesion and toner charge associated with development. That is, the development of a powder image with a geometry that is close to that of the latent image, i.e. no over development, line broadening, etc. For a printer with a resolution of 600 dpi, one dot (pel) has a diameter of about 40 microns (μ). Thus a 3 pel line width corresponds to a width of about 120μ and a four pel line has a width of about 160μ. The data in Table 1 therefore confirms that the conical mixer provides relatively closer values to the presumed lined widths as opposed to the Henschel mixer. The advantage of the conical mixer on line width quality also may become more pronounced as multiple adjacent pels are developed (3 pel v. 4 pel).

Voiding is a undesirable feature, whether a solid fill or a character, as it represents a loss in information. Characteristics that promote transfer of toner typically serve to minimize voiding. For example, rounder, as opposed to fractured particles promote transfer, which may particularly be the case at small relative particle size. Relatively larger EPA may also serve to promote transfer, which may be the result of the larger EPA acting as a spacer to help dislodge the particle from a surface upon which it rests. In any event, efficient distribution of the EPA on a given toner particle may improve the likelihood of efficient transfer. The conical mixer was observed to produce a toner with improved distribution of EPA as noted by the reduced voiding values (less information loss) which may particularly be the case at finer resolution (3 pel v. 4 pel).

The foregoing description is provided to illustrate and explain the present invention. However, the description hereinabove should not be considered to limit the scope of the invention set forth in the claims appended here to.

What is claimed is:

1. A method for adding extra particulate additive to chemically processed toner comprising:
combining chemically processed toner and extra particulate additive to form a mixture in a conical mixer wherein said toner comprises polymeric material having a glass transition temperature (Tg) and mixing is carried out wherein said mixture is maintained at a temperature less than Tg.

2. The method of claim 1 wherein said temperature of said mixture is maintained at a temperature of about 5° C. or more below Tg.

3. The method of claim 1 wherein said toner comprises a plurality of polymer materials each having a Tg including a lowest relative Tg wherein the temperature of said mixture is maintained at a temperature that is lower than said lowest relative Tg.

4. The method of claim 1 wherein said conical mixer includes a rotor and one or more mixing paddles which may be controlled to a selected (RPM) value for a selected time (T).

5. The method of claim 4 wherein said mixing is carried out in a plurality of stages, each stage having a selected RPM value and time T for mixing.

6. The method of claim 5, wherein
RPM₁<RPM₂ and
T₂>T₁
wherein RPM₁ represents the conical rotor rpm in stage 1, RPM₂ represents the conical rotor rpm in stage 2, T₁ represents the time for mixing in stage 1 and T₂ represents the time for mixing in stage 2.

7. The method of claim 1 wherein said extra particulate additive is present at a level of less than about 5.0% (wt.) within said toner.

8. The method of claim 1 wherein prior to said step of mixing said toner and said extra particulate additive is mechanically agitated.

9. The method of claim 8 wherein said step of mechanical agitation is carried out wherein said temperature of said toner is maintained at a temperature of less than Tg.

10. The method of claim 8 wherein said toner is maintained at a temperature of about 5° C. or more below Tg.

11. The method of claim 1 wherein said chemically processed toner includes toner particles having a particle diameter in the range of about 1-25 microns.

12. The method of claim 1 wherein said extra particulate additive comprises an inorganic oxide having a width of about 0.01 to 10 microns and a length between about 1-100 microns.

13. The method of claim 1 wherein said toner includes a release agent at a concentration of greater than about 3.0% (wt).

14. The method of claim 1 wherein said toner has a complex viscosity of between about 500 to 1500 Pa·s at 160° C.

15. A method for adding extra particulate additive to chemically processed toner comprising:
combining chemically processed toner and extra particulate additive to form a mixture in a conical mixer having a rotor and one or more mixing paddles;
said toner comprises polymeric material having a glass transition temperature (Tg) and mixing is carried out in a plurality of stages each having a selected RPM value and time T for mixing wherein
RPM₁<RPM₂ and
T₂>T₁
wherein RPM₁ represents the conical rotor rpm in stage 1, RPM₂ represents the conical rotor rpm in stage 2, T₁ represents the time for mixing in stage 1 and T₂ represents the time for mixing in stage 2; and
wherein said mixture is maintained at a temperature less than Tg and said extra particulate additive is present at a level of less than about 5.0% (wt.) within said toner.

16. The method of claim 15 wherein said mixture is maintained at a temperature of about 5° C. or more below Tg.

17. The method of claim 15 wherein said toner includes a release agent at a concentration of greater than about 3.0% (wt).

18. A method for adding extra particulate additive to chemically processed toner comprising:
combining chemically processed toner including toner particles having a particle diameter in the range of about 1-25 microns and extra particulate additive to form a mixture in a conical mixer wherein said toner comprises a plurality of polymer materials, each having a Tg including a lowest relative Tg wherein the temperature of said mixture is maintained at a temperature that is lower than said lowest relative Tg

19. The method of claim 1 wherein said mixture is maintained at a temperature of about 5° C. or more below said lowest relative Tg.

20. The method of claim 1 wherein said toner includes a release agent at a concentration of greater than about 3.0% (wt).
